(19) United States
(12) Patent Application Publication
(10) Pub. No.: US 2026/0298070 A1
(43) Pub. Date: Oct. 1, 2026

(54) DRILLING SYSTEM FOR LITHIUM RECOVERY

(71) Applicant: SAUDI ARABIAN OIL COMPANY, Dhahran (SA)

(72) Inventors: Klemens Katterbauer, Dhahran (SA); Abdulaziz S. Al-Qasim, Dammam (SA); Abdallah A. AlShehri, Dhahran (SA); Ali Abdallah AIYousef, Dhahran (SA)

(73) Assignee: SAUDI ARABIAN OIL COMPANY, Dhahran (SA)

(21) Appl. No.: 19/097,652

(22) Filed: Apr. 1, 2025

(51) Int. Cl. E21B 44/02; E21B 47/12; G01N 27/403

(52) U.S. Cl. CPC E21B 44/02; E21B 47/138; G01N 27/4035

(57) ABSTRACT

A drilling system, which includes a drilling body, a sensor unit disposed in the drilling body and a control system in electrical communication with the sensor unit, is provided. The drilling system is configured to extract lithium from a subsurface environment, the sensor unit is configured to determine a value of a concentration of ionic lithium in the subsurface environment and to transmit the value to the control system, and the control system is configured to control a drilling parameter based on the value.

### BACKGROUND

Lithium and its compounds are widely used in manufactured glass, ceramics, greases, batteries, refrigerants, chemical reagents and other industries. Lithium demand is expected to grow continuously and dramatically in the coming years as different types of lithium batteries are promising candidates for powering electric and hybrid vehicles. Lithium batteries include such as a lithium-ion battery, lithium-sulfur battery, and lithium-air battery.

A subsurface environment is an attractive resource for recovering valuable minerals such as lithium. While the concentration of ionic lithium is quite low (~0.17 ppm) in seawater, brine in a subsurface environment includes ionic lithium in concentrations as high as 10²-10³ ppm. However, there exists a need for developing an efficient lithium recovery system and a process from the subsurface environment. The development of new, energy-efficient lithium recovery techniques with higher throughput may significantly decrease the cost of extracting lithium from traditional reserves as well as underutilized resources.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a drilling system, which includes a drilling body, a sensor unit disposed in the drilling body and a control system in electrical communication with the sensor unit. The drilling system is configured to extract lithium from a subsurface environment, the sensor unit is configured to determine a value of a concentration of ionic lithium in the subsurface environment and to transmit the value to the control system, and the control system is configured to control a drilling parameter based on the value.

In another aspect, embodiments disclosed herein relate to a method includes running a drilling body in a subsurface environment, in which a sensor unit is disposed, gathering information concerning ionic lithium in the subsurface environment with an ion-selective sensor in the sensor unit, determining a value of a concentration of the ionic lithium with a microprocessor in the sensor unit, transmitting the value from the sensor unit to a control system in electrical communication and controlling a drilling parameter based on the value.

Other aspects and advantages of the claimed subject matter will be apparent from the following description and the appended claims.

### BRIEF DESCRIPTION OF DRAWINGS

FIG. 1 illustrates a well environment according to one or more embodiments of the present disclosure.

FIG. 2 illustrates a radial jet drilling system according to one or more embodiments of the present disclosure.

FIG. 3 illustrates a network system according to one or more embodiments of the present disclosure.

FIG. 4 illustrates a sensor unit according to one or more embodiments of the present disclosure.

FIG. 5 illustrates a control system according to one or more embodiments of the present disclosure.

FIG. 6 illustrates a computing unit according to one or more embodiments of the present disclosure.

FIG. 7 illustrates a flow chart of a method for lithium recovery according to one or more embodiments of the present disclosure.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments disclosed herein include a drilling system and process for extracting lithium from a subsurface environment. In accordance with one or more embodiments, the subsurface environment includes brine which carry ionic lithium in concentrations as high as 10²-10³ ppm. The drilling system includes a drilling body, a sensor unit disposed in the drilling body and a control system in electrical communication with the sensor unit. The electrical communication may be wireless communication or wired communication. The sensor unit is configured to determine a value of a concentration of ionic lithium in the subsurface environment and to transmit the value to the control system, and the control system is configured to control a drilling parameter based on the value. In addition to the value of a concentration of ionic lithium, the rate of penetration (ROP), the weight of bit (WOB), the flow rate of the fluid, downhole pressure and downhole temperature may be used to determine the drilling parameters.

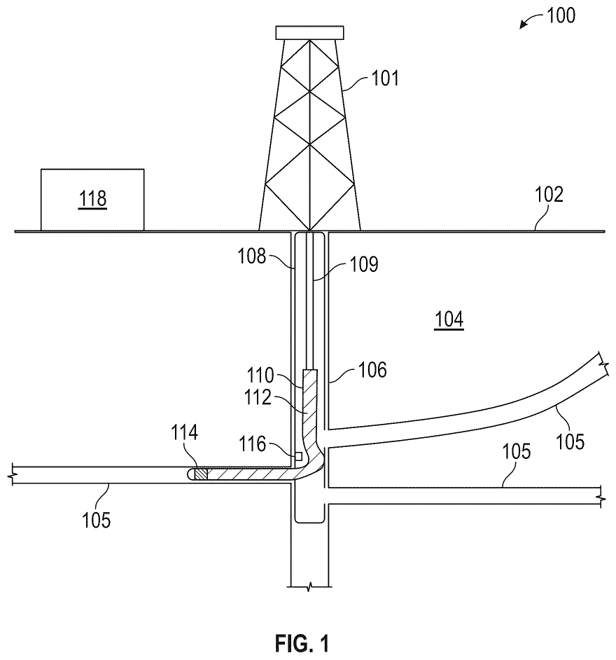

FIG. 1 illustrates an exemplary well environment (100) including a rig (101) and a wellbore (106) extending into a subsurface environment (104). The wellbore (106) may include a bored hole that extends from the surface (102) into a target zone of the subsurface environment (104), such as a reservoir. A casing (108) may be installed in the wellbore (106). The casing (108) may be perforated to have perforations into the target subsurface environment (104) to allow a flow of reservoir fluid to enter the wellbore (106). The well environment (100) may include a drilling system (110). The drilling system (110) may be configured to locate where high concentration of ionic lithium exists in the subsurface environment (104) and extract lithium from the subsurface environment (104). The drilling system (110) may include a drilling body (112), a sensor unit (114) and a control system (116). The drilling system may further include a computing unit (118). The drilling system (110) may be connected to a coil tubing (109).

In accordance with one or more embodiments, the sensor unit (114) is disposed in the drilling body (112) and the control system (116) is in electrical communication with the sensor unit (114). The sensor unit (114) may be configured to determine the value of the concentration of ionic lithium in the subsurface environment (104) and to transmit the value to the control system (116). The control system (116) may be configured to control a drilling parameter based on the value.

In one or more embodiments, the sensor unit may be disposed proximate to a nozzle of the drilling body. The position of the sensor unit may be further customized depending on the subsurface environment and the drilling conditions. A plurality of sensors may be disposed in the drilling body.

In accordance with one or more embodiments, the drilling body (112) is a jet type (i.e. jet drilling body), a radial type (i.e. radial drilling body) or combinations thereof (i.e. radial jet drilling body). Thus, the drilling system (110) may be a jet drilling system, radial drilling system, or radial jet drilling system. The jet drilling body jets a fluid to perforate cavities (105) in the subsurface environment. Creating such cavities (105) where high concentration of ionic lithium exists with the drilling system (110) may efficiently increase the surface area of the wellbore (106) for lithium extraction. The fluid may be water. Abrasive particles may be added to the water to enhance the effect of a high-pressure velocity jet. Examples of the abrasive particles may include, but are not limited to, micro glass beads and polymer particles. The fluid may be an acid like hydrochloric acid. The acid fluid may be used when the jet drilling body runs into a water-sensitive formation.

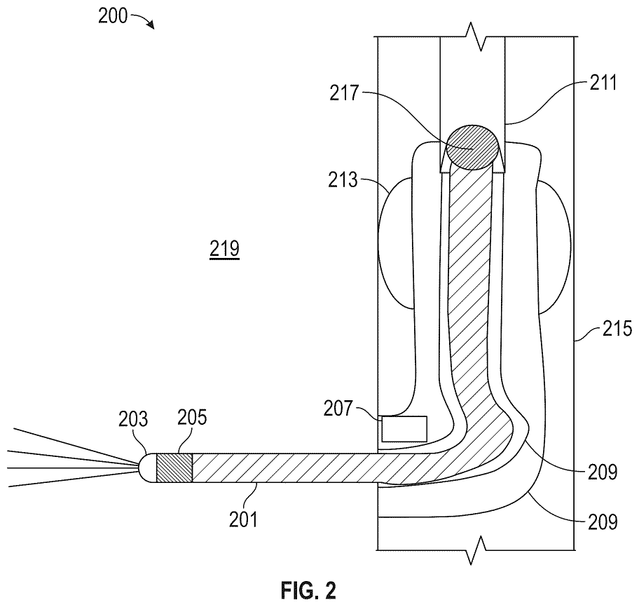

FIG. 2 illustrates an exemplary radial jet drilling system (200). The radial jet drilling system (200) may include a radial jet drilling body (201), a sensor unit (205) and a control system (207). In one or more embodiments, the radial jet drilling body (201) is attached to the coil tubing (211), and the radial jet drilling body (201) and the control system (207) may be located inside the casing (215). A screw motor may be located between the radial jet drilling body (201) and the coil tubing (211) to rotate the radial jet drilling body (201). The radial jet drilling system (200) may further include a communication cable in the coil tubing (211), a casing cutter, a small diameter bit, a mud motor, an anchor, an orienter and a steering tool.

In one or more embodiments, the radial jet drilling body (201) drills a hole in the casing (215) and runs into the subsurface environment (219) with the sensor unit (205) which is disposed proximate to the nozzle (203) of the radial jet drilling body (201). In general, the radial jet drilling system (200) is designed to cut a wide range of hard-to-soft materials. The radial jet drilling system (200) may drill perforations having small bending diameter in the radial direction using high pressure water jets.

In accordance with one or more embodiments, the radial jet drilling body (201) runs radially to explore ionic lithium in the subsurface environment (219). It will be understood that the radial direction is not limited to horizontal to the surface. For example, the radial jet drilling body (201) may initially run perpendicular to the wellbore and then may change direction to go upward or downward. Further, the wellbore is not limited to vertical as shown in FIG. 1. The radial jet drilling body (201) may be constructed of a flexible hose or a flexible tubing. In one or more embodiments, the flexible hose is a high-pressure flexible hose. The radial jet drilling body (201) may have a bend radius as small as about 2 inches. The outer diameter of the radial jet drilling body (201) may be between 0.3 inch and 5 inches. The design such as the bend radius and the outer diameter may further be customized depending on the drilling conditions. The radial jet drilling body (201) may include the nozzle (203) at the distal tip of the radial jet drilling body. The radial jet drilling body (201) may include one or more nozzles (203). The diameter of the nozzle may be between 0.3 inch and 5 inches. The length of the nozzle may be between 0.5 inch and 5 inches. The diameter and length of the nozzle may be further customized depending on the subsurface environment and the drilling conditions. The nozzle may further include one or more orifices.

In one or more embodiments, high-pressure fluid may be circulated through forward and back nozzles connected to the radial jet drilling body (201). The fluid leaving the forward nozzle may be used to erode and drill the subsurface environment while the fluid leaving the backward nozzle may be used to push the nozzle forward and to widen the laterals drilled. The high-pressure fluid may contain abrasive materials. The radial jet drilling body may be used, but is not limited to, at marginal fields for lithium recovery where the lithium recovery rate from the subsurface environment by water injection is not sufficiently high.

In one or more embodiments, the radial jet drilling body (201) is coupled to the coil tubing (211) or the screw motor with a connector (217). The connector may be a screw connector or a flex connector. A hydraulic piston (not shown) may be attached to the connector (217).

In accordance with one or more embodiments, a deflector shoe (209) is mounted to the radial jet drilling system (200). The deflector shoe (209) may have an interior passage which directs the radial jet drilling body in a lateral direction to the wellbore (106). The deflector shoe (209) may be lowered into the well using the casing to reach the target and oriented using a gyro. The radial jet drilling body (201) may have a curved portion in the deflector shoe (209) and a lateral portion guiding the nozzle (203) into the subsurface environment horizontally. A centralizer (213) may be disposed proximate to the deflector shoe to centralize the drilling system in the casing.

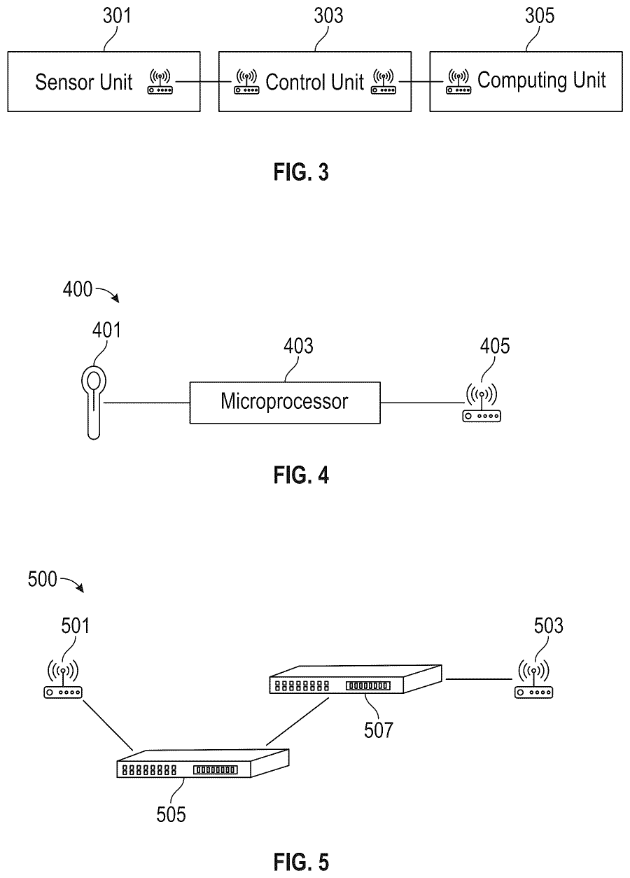

FIG. 3 illustrates an exemplary network system in accordance with one or more embodiments. The sensor unit (301) is configured to determine the value of the concentration of ionic lithium and transmit the value to the control system (303). The control system (303) controls the drilling parameters based on the value of the concentration of ionic lithium. In one or more embodiments, the control system (303) transmits the value to the computing unit (305), and the computing unit (305) determines respective values of one or more drilling parameter based on the value of the concentration of ionic lithium and transmit the value to the control system (303). The control system (303) may be configured to obtain the value of the drilling parameter in the electrical communication from the computing unit (305) and control the drilling parameters.

In one or more embodiments, while the drilling body is running in the subsurface environment, the value of the concentration of ionic lithium obtained at the sensor unit (301) is transmitted to the computing unit (305) through the control system (303) in the electrical communication and the computing unit (305) determines respective values of one or more drilling parameter based on the value of the concentration of ionic lithium. The value of the concentration of ionic lithium may be transmitted to the computing unit (305) from the sensor unit (301) directly. The sensor unit (301) may transmit the value of the concentration of ionic lithium in real-time uphole via fiber optic communication, which sends pulses of infrared or visible light through an optical fiber. The electrical communication may be a low-latency wireless communication. Any combination of mobile, desktop, server, router, switch, embedded device, or other types of hardware may be used. While running in the subsurface environment, real-time change in the drilling may be made in response to the value of the concentration of ionic lithium in the subsurface environment (104). The change in the drilling may be adjustment of drilling parameters by the control system (303). For instance, failing to achieve a desired minimum threshold level of ionic lithium (e.g., 50-75 ppm) indicates that the extraction efficiency is lacking. Therefore, the drilling parameters (e.g., jetting speed, jetting pressure, jetting direction) may be adjusted by the control system (303) to increase the lithium extraction efficiency. If real-time data is not needed, the value may be stored in a memory and used for later determination of respective values of one or more drilling parameters based on the value of the concentration of ionic lithium once the drilling body (112) is pulled to the surface (102) and to be used in later drilling with the drilling system.

Referring to FIG. 4, a sensor unit (400) includes an ion-selective sensor (401), a microprocessor (403) and a wireless communication unit (405). The ion-selective sensor (401), the microprocessor (403) and the wireless communication unit (405) may be connected through a robust interface, allowing for seamless communication and data transmission in harsh downhole environments. The temperature of the harsh downhole environments may be over 200° C. and/or the H₂S concentration of the harsh downhole environment may be more than 30 %. The sensor unit (400) may be a field programmable Gate Arrays (colloquially referred to as FPGA) sensor unit which can work under the harsh downhole environment.

In accordance with one or more embodiments, the ion-selective sensor is configured to gather information concerning ionic lithium in the subsurface environment. The ion-selective sensor (401) may include an ion-selective electrode including a lithium ionophore. The ion-selective electrode may further include a polymeric membrane doped with the lithium ionophore. Different types of the lithium ionophore may be used as long as the lithium ionophore has affinities for lithium-ion. Examples of the lithium ionophore may include, but are not limited to, crown ethers type, cryptands type, lariat ethers type, neutral carriers type like valinomycin analogues and combinations thereof. Examples of crown ether type may include, but are not limited to, dibenzo-16-crown-5 ether derivatives, bis(crown ether)s derivatives and combinations thereof. The ion-selective sensor (401) may further include a reference electrode for improving accuracy. Examples of the reference electrode may be Ag/AgCl or calomel electrode.

In one or more embodiments, the ion-selective sensor includes a signal processing component which processes the analysis of digital signals to improve the accuracy of the value of the concentration of ionic lithium. The signal processing unit may incorporate elements of model predictive control and Kalman filtering which enable to fuse the information concerning ionic lithium obtained by the ion-selective sensor, correct for noise and errors, and generate a compressive picture of the information concerning ionic lithium in the subsurface environment. Imaging techniques may be applied to interpret the gathered value and infer valuable insights about ionic lithium in the subsurface environment. Examples of the imaging techniques may include seismic inversion, electrical resistivity tomography (ERT), induced polarization (IP) and combinations thereof. The ion-selective sensor (401) may receive ionic lithium through a sampling unit. The sampling unit may be configured to obtain a sample from the subsurface environment and send the sample to the ion-selective sensor. The sampling unit may obtain a sample via a dedicated port or diffusion through a semi-permeable membrane, allowing ionic lithium to flow from the surrounding formation fluids in the subsurface environment such as brine into the sensor unit.

In accordance with one or more embodiments, the microprocessor (403) is connected to the ion-selective sensor (401) in electrical communication. The microprocessor (403) may be configured to receive the information concerning the ionic lithium and determine the value of the concentration of ionic lithium

In accordance with one or more embodiments, the wireless communication unit (405) is connected to the microprocessor (403) in electrical communication. The wireless communication unit (405) may be configured to transmit the value of the concentration of ionic lithium to the control system (303). The electrical communication may be wireless communication. The electrical communication may be the low-latency wireless communication. The low-latency wireless communication enables prompt and efficient transmission of critical real-time data, allowing for timely decision-making and optimizing operations.

Referring FIG. 5, the control system (500) is configured to control the drilling parameters based on the value of the concentration of ionic lithium. In one or more embodiments, the drilling parameters include, but are not limited to, a jetting speed, a jetting pressure, a jetting direction and combinations thereof. The drilling parameters may further include stand-off distance (the distance between the drilling body and the subsurface environment), abrasive mass flow rate (the mixing ratio between abrasive particles and the fluid), abrasive particles (type, shape, size and hardness), nozzle size (length and diameter) and orifice diameter. The control system (500) may include one or more wireless communication units (501, 503) and one or more relay units. When there is more than one relay unit, each relay unit is herein termed a distributed unit (505, 507). The wireless communication units (501, 503) may enable wireless communication with the sensor system and the computing unit. The wireless communication may be the low-latency wireless communication. The low-latency wireless communication may be delivered by a Zigbee-based wireless system. The distributed units (505, 507) connecting the wireless communication unit (501, 503) may be designed to facilitate decentralized processing and data analysis for controlling the drilling body while electrically communicating with the computing unit.

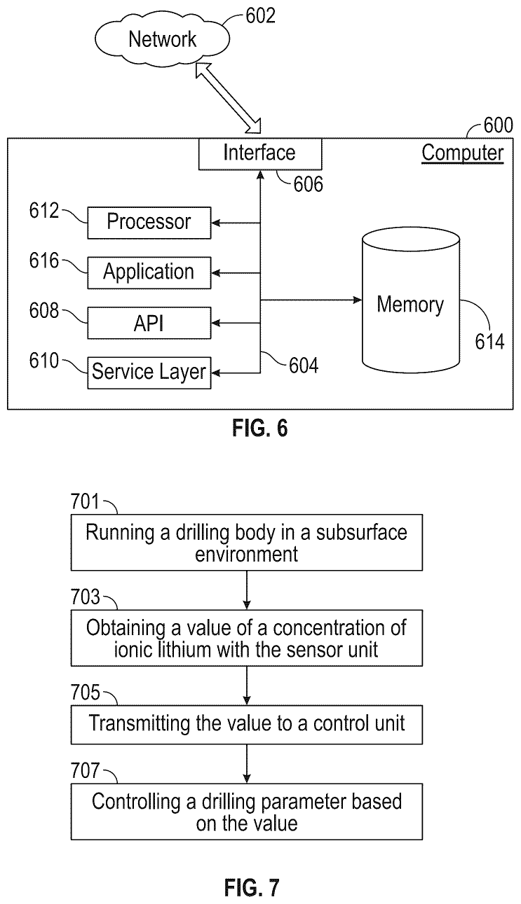

FIG. 6 further depicts a block diagram of a computing unit (600) used to provide computational functionalities associated with described algorithms, methods, functions, processes, flows, and procedures as described in this disclosure, according to one or more embodiments. Specifically, the computing unit (600) may be configured to receive the value of the concentration of the ionic lithium from the control system or the sensor unit and determine respective values of one or more drilling parameters based on the value of the concentration of ionic lithium. The computing unit (600) may transmit the respective values of one or more the drilling parameters to the control system.

The illustrated computing unit (600) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computing unit (600) may include an input device, such as a keypad, keyboard, touch screen, or other device that can accept user information, and an output device that conveys information associated with the operation of the computing unit (600), including digital data, visual, or audio information (or a combination of information), or a GUI.

The computing unit (600) can serve in a role as a client, network component, a server, a database or other persistency, or any other component (or a combination of roles) of a computer system for performing the subject matter described in the instant disclosure. The illustrated computing unit (600) may be communicably coupled with a network (602). In some implementations, one or more components of the computing unit (600) are configured to operate within environments, including cloud-computing-based, local, global, or other environment (or a combination of environments).

At a high level, the computing unit (600) is an electronic computing device operable to receive, transmit, process, store, or manage data and information associated with the described subject matter. According to some implementations, the computing unit (600) may also include or be communicably coupled with an application server, e-mail server, web server, caching server, streaming data server, business intelligence (BI) server, or other server (or a combination of servers).

In accordance with one or more embodiments, the computing unit (600) may receive requests over network (602) from a client application (for example, executing on another computer) and responding to the received requests by processing the said requests in an appropriate software application. In addition, requests may also be sent to the computing unit (600) from internal users (for example, from a command console or by other appropriate access method), external or third-parties, other automated applications, as well as any other appropriate entities, individuals, systems, or computers.

In one or more embodiments, each of the components of the computing unit (600) may communicate using a system bus (604). In some implementations, any or all of the components of the computing unit (600), both hardware or software (or a combination of hardware and software), may interface with each other or the interface (606) (or a combination of both) over the system bus (604) using an application programming interface (API) (608) or a service layer (610) (or a combination of the API (608) and service layer (610)). The API (608) may include specifications for routines, data structures, and object classes. The API (608) may be either computer-language independent or dependent and refer to a complete interface, a single function, or even a set of APIs. The service layer (610) provides software services to the computing unit (600) or other components (whether or not illustrated) that are communicably coupled to the computing unit (600). The functionality of the computing unit (600) may be accessible for all service consumers using this service layer. Software services, such as those provided by the service layer (610), provide reusable, defined business functionalities through a defined interface. For example, the interface may be software written in JAVA, C++, or other suitable language providing data in extensible markup language (XML) format or another suitable format. While illustrated as an integrated component of the computing unit (600), alternative implementations may illustrate the API (608) or the service layer (610) as stand-alone components in relation to other components of the computing unit (600) or other components (whether or not illustrated) that are communicably coupled to the computer (600). Moreover, any or all parts of the API (608) or the service layer (610) may be implemented as child or sub-modules of another software module, enterprise application, or hardware module without departing from the scope of this disclosure.

In one or more embodiments, the computing unit (600) includes an interface (606). Although illustrated as a single interface (606) in FIG. 6, two or more interfaces (606) may be used according to particular needs, desires, or particular implementations of the computer (600). The interface (606) is used by the computing unit (600) for communicating with other systems in a distributed environment that are connected to the network (602) to facilitate decentralized processing and data analysis. Generally, the interface (606) includes logic encoded in software or hardware (or a combination of software and hardware) and operable to communicate with the network (602). More specifically, the interface (606) may include software supporting one or more communication protocols associated with communications such that the network (602) or interface's hardware is operable to communicate physical signals within and outside of the illustrated computing unit (600).

In one or more embodiments, the computing unit (600) includes at least one computer processor (612). Although illustrated as a single computer processor (612) in FIG. 6, two or more processors may be used according to particular needs, desires, or particular implementations of the computing unit (600). Generally, the computer processor (612) executes instructions and manipulates data to perform the operations of the computing unit (600) and any algorithms, methods, functions, processes, flows, and procedures as described in the instant disclosure.

In accordance with one or more embodiments, the computing unit (600) also includes a memory (614) that holds data for the computing unit (600) or other components (or a combination of both) that can be connected to the network (602). For example, memory (614) can be a database storing data consistent with this disclosure. Although illustrated as a single memory (614) in FIG. 6, two or more memories may be used according to particular needs, desires, or particular implementations of the computing unit (600) and the described functionality. While memory (614) is illustrated as an integral component of the computing unit (600), in alternative implementations, memory (614) can be external to the computing unit (600).

In accordance with one or more embodiments, the application (616) is an algorithmic software engine providing functionality according to particular needs, desires, or particular implementations of the computing unit (600), particularly with respect to functionality described in this disclosure. For example, the application (616) can serve as one or more components, modules, applications, etc. Further, although illustrated as a single application (616), the application (616) may be implemented as multiple applications (616) on the computing unit (600). In addition, although illustrated as integral to the computing unit (600), in alternative implementations, the application (616) can be external to the computing unit (600).

There may be any number of computing unit (600) associated with, or external to, a computer system containing the computing unit (600), wherein each computer communicates over network (602). Further, the term “client,” “user,” and other appropriate terminology may be used interchangeably as appropriate without departing from the scope of this disclosure. Moreover, this disclosure contemplates that many users may use one computer, or that one user may use multiple computers.

In accordance with one or more embodiments, a power module may be configured to power, at least, the drilling body (112), the sensor unit (114), the control system (116) and the computing unit (118) though any suitable power element, such as one or more batteries and one or more power cables. The power cable may run from the surface throughout the coil tubing. The battery may be a lithium-thionyl chloride battery or a lithium-ion battery. One or more batteries may be combined with energy-harvesting mechanisms such as a piezoelectric generator or a thermoelectric converter to scavenge energy from an ambient source. The ambient source may be vibrations, heat or combinations thereof. Power management ICs and dedicated software may work together to minimize power consumption to prolong battery life by employing strategies. The strategies may be dynamic voltage and frequency scaling, sleep modes, wake-up or combinations thereof.

FIG. 7 shows a flowchart in accordance with one or more embodiments. The flowchart illustrates a method for lithium recovery from the subsurface environment.

In step (701), the drilling body is deployed in the subsurface environment and conducts the drilling operations. In step (703), while the drilling body is running in the subsurface environment, the sensor unit disposed in the drilling body obtains the value of the concentration of ionic lithium. In step (705), the sensor unit transmits the value of the concentration of ionic lithium to the control system. In step (707), the control system controls the drilling parameters based on the value of the concentration of ionic lithium. The computing unit may further process the value of the concentration of ionic lithium prior to controlling the drilling parameter at the control system. The processing includes transmitting the value of the concentration of ionic lithium to the computing unit from the control system in electrical communication, determining respective values of one or more drilling parameters based on the value of the concentration of ionic lithium with the computing unit, and transmitting the value of the drilling parameter to the control system in the electrical communication.

In one or more embodiments, the brine is pumped out from the subsurface environment and lithium is extracted from the brine. Lithium extraction may be conducted, but is not limited to, by mixing with an organic solvent including a lithium ionophore and extracting lithium from the organic solvent. Examples of the lithium ionophore may include, but are not limited to, dibenzo-16-crown-5 ether derivatives, bis(crown ether)s derivatives and combinations thereof. The concentration of the lithium ionophore in the organic solvent may be 1 mM or more and 10 mM or less. Examples of organic solvents may include, but are not limited to, dichloromethane, toluene and combinations thereof. Lithium may be extracted from the organic solvent including the lithium ionophore and ionic lithium.

Embodiments of the present disclosure may provide at least one of the following advantages. The drilling system described herein enables the determination of in-situ lithium concentration and controls the drilling parameters to allow the drilling body to run in the subsurface environment where high concentration of ionic lithium exists.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures.

1. A drilling system comprising:
a drilling body;
a sensor unit disposed in the drilling body; and
a control system in electrical communication with the sensor unit, wherein:
the drilling system is configured to extract lithium from a subsurface environment;
the sensor unit is configured to determine a value of a concentration of ionic lithium in the subsurface environment and to transmit the value to the control system; and
the control system is configured to control a drilling parameter based on the value.

2. The drilling system of claim 1, wherein the sensor unit comprises:
an ion-selective sensor configured to gather information concerning the ionic lithium;
a microprocessor connected to the ion-selective sensor, wherein the microprocessor is configured to receive the information and determine the value of the concentration of the ionic lithium; and
a wireless communication unit connected to the microprocessor, wherein the wireless communication unit is configured to transmit the value of the concentration of the ionic lithium to the control system.

3. The drilling system of claim 2, wherein the ion-selective sensor comprises an ion-selective electrode.

4. The drilling system of claim 3, wherein the ion-selective electrode comprises a lithium ionophore.

5. The drilling system of claim 4, wherein the lithium ionophore is selected from the group consisting of a dibenzo-16-crown-5 ether derivative, a bis(crown ether)s derivative and combinations thereof.

6. The drilling system of claim 1, wherein the drilling body comprises a nozzle, wherein the sensor unit is disposed proximate to the nozzle.

7. The drilling system of claim 1, wherein the subsurface environment comprises brine and the sensor unit is configured to determine a value of a concentration of ionic lithium in the brine.

8. The drilling system of claim 1, wherein the electrical communication between the sensor unit and the control system is in a low-latency wireless communication.

9. The drilling system of claim 1, wherein the control system is proximate to the drilling body.

10. The drilling system of claim 1, wherein the drilling body is a radial jet drilling body having a flexible hose, wherein the radial jet drilling body is configured to drill radially into the subsurface environment.

11. The drilling system of claim 10, wherein the control system is configured to control the drilling parameter, wherein the parameter is selected from the group consisting of a jetting speed, a jetting pressure, a jetting direction and combinations thereof.

12. The drilling system of claim 1, further comprising a computing unit at a surface of the subsurface environment, wherein:
the control system is configured to transmit the value of the concentration of the ionic lithium to the computing unit in electrical communication;
the computing unit is configured to determine a value of the drilling parameter based on the value of the concentration of the ionic lithium and transmit the value of the drilling parameter to the control system in the electrical communication; and
the control system is configured to obtain the value of the drilling parameter from the computing unit and control the drilling parameter.

13. The drilling system of claim 1, further comprising a power module in the sensor unit, wherein the power module comprises a piezoelectric generator or a thermoelectric converter.

14. The drilling system of claim 2, wherein the ion-selective sensor further comprises a signal processing component, wherein the signal processing component is configured to analyze the information concerning the ionic lithium obtained by the ion-selective sensor.

15. A method comprising:
running a drilling body in a subsurface environment, wherein a sensor unit is disposed in the drilling body;
gathering information concerning ionic lithium in the subsurface environment with an ion-selective sensor in the sensor unit;
determining a value of a concentration of the ionic lithium with a microprocessor in the sensor unit;
transmitting the value from the sensor unit to a control system in electrical communication; and
controlling a drilling parameter based on the value.

16. The method of claim 15, further comprising processing the value of the concentration of the ionic lithium prior to controlling the drilling parameter wherein the processing comprises:
transmitting the value of the concentration of the ionic lithium to a computing unit from the control system in electrical communication;
determining a value of the drilling parameter based on the value of the concentration of the ionic lithium with the computing unit; and
transmitting the value of the drilling parameter to the control system in the electrical communication.

17. The method of claim 16, wherein the electrical communication between the sensor unit, the control system and the computing unit is in a low-latency wireless communication.

18. The method of claim 15, wherein running the drilling body comprises running a radial jet drilling body radially into the subsurface environment.

19. The method of claim 15, wherein the drilling parameter is selected from the group consisting of a jetting speed, a jetting pressure, a jetting direction and combinations thereof.

20. The method of claim 15, further comprising pumping out brine in the subsurface environment and extracting lithium from the brine.
